(19) United States
(12) Patent Application Publication
(10) Pub. No.: US 2026/0257352 A1
(43) Pub. Date: Sep. 3, 2026

(54) IN-CONTEXT LEARNING TO ENABLE ROBOT ACTION PREDICTION IN LARGE LANGUAGE MODELS

(71) Applicant: THE REGENTS OF THE UNIVERSITY OF CALIFORNIA, Oakland, CA (US)

(72) Inventors: Trevor Darrell, Berkeley, CA (US); Zekai Wang, Berkeley, CA (US); Dantong Niu, Berkeley, CA (US); Yuvan Sharma, San Jose, CA (US); Yida Yin, Princeton, NJ (US)

(21) Appl. No.: 19/551,224

(22) Filed: Feb. 26, 2026

Related U.S. Application Data
(60) Provisional application No. 63/764,678, filed on Feb. 28, 2025.

(51) Int. Cl. B25J 9/16; G06T 7/70; G06V 20/40

(52) U.S. Cl. CPC B25J 9/163; G06T 7/70; G06V 20/46

(57) ABSTRACT

A robotic device includes a large-language model that uses in-context learning to predict robot actions without additional training. The robotic device may include one or more processors configured to execute code that causes the one or more processors to use in-context learning. A method of using a large-language model in a robotic device to predict robot actions includes using in-context learning without additional training.

### CROSS-REFERENCE TO RELATED APPLICATIONS

This disclosure is a non-provisional of and claims benefit from U.S. Provisional Patent Application No. 63/764,678, filed Feb. 28, 2025, titled “IN-CONTEXT LEARNING TO ENABLE ROBOT ACTION PREDICTION IN LARGE LANGUAGE MODELS,” the disclosure of which is incorporated herein by reference in its entirety.

### TECHNICAL FIELD

This disclosure relates to large-language models (LLMs), more specifically to LLMs that can predict robot actions through in-context learning.

### BACKGROUND

Recently, Large Language Models (LLMs), such as GPT-4, Claude-3.5, and Llama-3.1, have demonstrated state-of-the-art performance on a variety of language tasks. Interestingly, LLMs exhibit a powerful emergent property-in-context learning (ICL), where LLMs learn a new task during inference by conditioning on a few input-output demonstrations and making predictions for new, unseen inputs. Recent work has demonstrated that ICL enhances model performance in various language tasks. A natural question arises how to perform ICL in robotics using an off-the-shelf text-only LLM without training.

The first challenge in applying ICL in robotics is forming a compact and effective representation for ICL demonstrations. Recent research has shown that ICL performance greatly depends on the quality of the provided demonstrations. Moreover, simply adding a large number of inputs across a long context might lead to hallucinations and degraded performance. Therefore, it is critical to identify the essential parts within example episodes and use them to form ICL examples. Secondly, robot agents perform a specific task by mapping visual observation input, such as RGB and depth images, into robotic control output. However, the format of input and output is not generically compatible with text-only LLMs. To resolve this issue, the input and output need to be transformed into a text format that LLMs can process. Finally, LLMs are trained on a broad corpus of text by statistically predicting the next word from an input sequence. ICL further leverages this next token prediction capability for LLMs to learn a new task during inference by providing input-output demonstrations. Nevertheless, it is unclear what the input-output relationship should be when performing ICL for robotics.

### BRIEF DESCRIPTION OF THE DRAWINGS

FIGS. 1A-1C show an overview of an embodiment of a robotic prompt using a large-language models.

FIGS. 2A-2D shows a visualization of a first few predicted actions for a robotic prompt using a large-language models.

FIGS. 3A-3C shows graphs of results of ablations for a robotic prompt using a large-language model for robotics.

FIGS. 4A-4C shows graphs of results of additional experiments using a robotic prompt using large-language models.

FIG. 5 shows a photograph of a real-robot setup for evaluating a robotic prompt using large-language models.

### DETAILED DESCRIPTION OF THE EMBODIMENTS

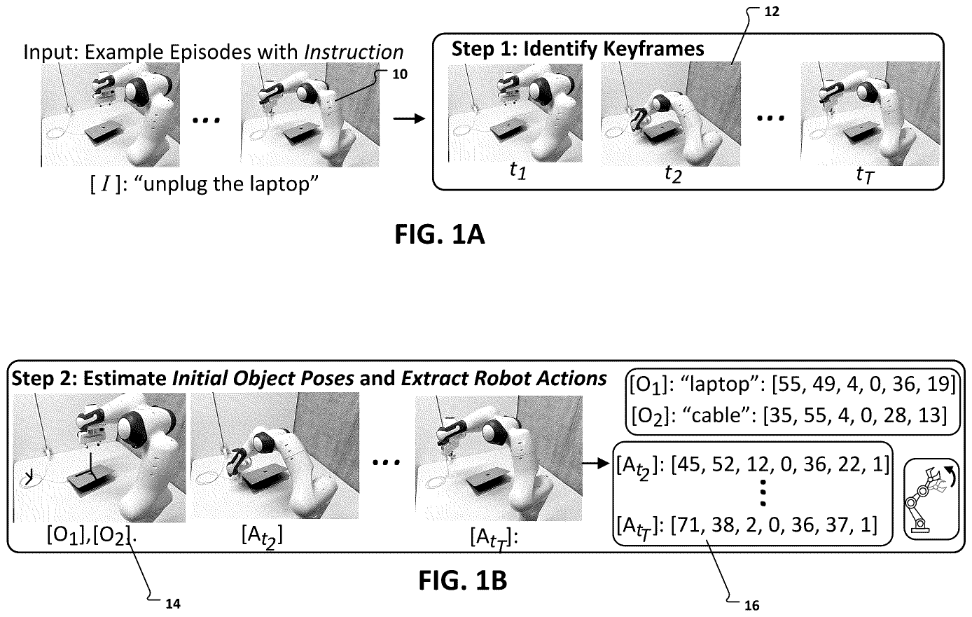

The embodiments herein involve a robotic prompt using a large-language models, referred to here as “RoboPrompt.” The embodiments of RoboPrompt include a framework that enables pretrained LLMs to directly predict robot actions based on ICL demonstrations. As shown in FIGS. 1A-1C, the method of the embodiments consists of three steps. First, as shown in FIG. 1A, keyframes such as 12 from an example video episode are identified by finding when the joint velocities of a robot 10 approach zero, or the gripper state transitions between open and closed. This keyframe extraction scheme captures important moments in an episode. Second, as shown in FIG. 1B, the object poses 14 at the first timestep are estimated by leveraging an off-the-shelf pose estimate model and extracting the robot actions from all the keyframes. The extracted robot actions are then converted and estimated object poses into textual descriptions 16. Third, as shown in FIG. 1C, these textual descriptions are paired together with a task instruction to form an ICL example 18 using a structured template. This allows an LLM 20 to predict robot actions directly based on new object poses from the test image and a test task instruction.

The robotic device as one or more processors configured to execute code that causes the one or more processors to perform the processes discussed here. The robotic device will include memory that stores the code, which may include the code comprising the large-language model.

Through extensive empirical evaluations, RoboPrompt has been shown that it enables off-the-shelf LLMs to directly predict robot actions via ICL. The method was assessed in 16 tasks from the RLBench simulation and 6 real-world tasks on a Franka Emika Panda robot. The results demonstrate RoboPrompt outperforms several zero-shot and in-context baselines. Finally, the ablation analysis indicates RoboPrompt can be applied to various LLMs, is robust to pose estimation errors, scales with the number of ICL examples, and performs competitively against supervised methods.

Recent success in LLMs and VLMs has driven various applications in robotics. To perceive the world, these models either rely on vision modality to parse image inputs directly or employ separate perception modules to extract scene representations and convert them into text format. Powered by the reasoning ability of LLMs, these models can break down high-level task descriptions into detailed, step-by-step plans. These plans can be expressed in various formats, such as natural language, executable code, or value maps. Finally, robots sequentially execute the generated plans using predefined motion primitives or separate low-level policies. While these methods demonstrate surprising zero-shot performance, they often require prompt engineering or handcrafted design. KAT addresses this with ICL examples by predicting action tokens, which can be transformed back to standard 6-DoF action. LLMs have also demonstrated the ability to utilize ICL for predicting joint positions, allowing a robot to walk. In contrast, the approach performs ICL directly in the space of 6-DoF object poses and end-effector actions, enabling the robot to perform manipulation tasks.

Recent research has focused on extending VLMs to output motion control by training on pairs of images and robot actions. These models are often referred to as Vision Language Action models (VLAs). For instance, RT-2 finetunes both robotic trajectory data and large-scale vision language tasks to improve robot control. RT-2-X scales up the performance using the expansive Open X-Embodiment dataset. RFM-1 further extends the multimodal approach to facilitate interactive human-robot communication by pretraining across five modalities (text, image, video, sensor data, and robot actions). LLARVA introduces an additional training objective of predicting intermediate 2D trajectories to align the vision and action spaces. OpenVLA incorporates an additional visual encoder DINOv2 to strengthen the visual grounding ability for robot learning. LLaRA generates auxiliary spatial-temporal datasets from existing robot data to enhance policy performance. HPT proposes to train a joint policy network across different embodiments and tasks to scale proprioceptive-visual learning. Compared with these methods, the approach does not require pretraining or finetuning on any data. By using off-the-self LLMs, one can acquire robotic skills through text-based ICL demonstrations.

With the increasing size of model and data, LLMs exhibit striking emergent ability-in-context learning (ICL). With a few input-output pairs as demonstrations, pretrained LLMs can generalize to new tasks without training by identifying patterns from these examples. ICL has been successfully applied across various domains, including traditional NLP tasks, benchmarks that demand complex reasoning, visual question answering, and robotics. The discussion here focuses on the potential of applying ICL for robotics rather than vision or language domains. By creating a textual prompt that contains robot actions from keyframes and initial object poses, the process exploits LLM's ICL capabilities to generate robot actions directly based on new object poses.

The problem of robot action prediction in the ICL setting is addressed using an off-the-shelf LLM without additional training. In ICL setting, an LLM, denoted as f(⋅), is provided with a set of n input-output examples

$${\{ ( {x}^{i} , {y}^{i} ) \}}_{i = 1}^{n} .$$

The model's task is to generate a response ŷ^{Test} for an unseen test query x^{Test} based on the provided examples:

$${\hat{y}}^{Test} = f ( {x}^{Test} \vert ( {x}^{1} , {y}^{1} ) , … , ( {x}^{1} , {y}^{1} ) ) . \qquad ( 1 )$$

Here, the embodiments use an LLM to perform ICL on robotic episodes. Each episode contains (i) a task instruction I; (ii) an RGB-D image V capturing the environment setup at the first timestep from a calibrated camera; (iii) a sequence of 7-DoF joint velocities

$${\{ {S}_{t} \}}_{t = 1}^{T} ;$$

and (iv) a sequence of end-effector actions

$${\{ {A}_{t} \}}_{t = 1}^{T} ;$$

where each Aᵢ consists of a 6-DoF pose (e.g., translation and rotation in Euler angles) in the world frame W and a gripper state:

$${A}_{t} = [ {A}_{t}^{translation} , {A}_{t}^{rotation} , {A}_{t}^{g ripper} ] .$$

To address the challenge of performing ICL in robotics, the embodiments present RoboPrompt, a framework that enables an off-the-shelf LLM to directly predict robot actions through ICL without additional training. FIGS. 1A-1C illustrates the three-step approach. First, the process identifies keyframes where critical robot actions occur within each example episode. Then, the process extracts robot actions from these keyframes and estimate object poses in the environment at the first timestep. Last, ICL demonstrations were constructed and fed them into the LLM to predict actions.

As mentioned above, the ICL performance of LLMs greatly depends on the quality of selected demonstrations. One would like to select the frames that contain critical information. The embodiments identify when important actions of the robot happen based on two criteria: (i) the joint velocities St are near zero; or (ii) the gripper state

$${A}_{T}^{g r i p p e r}$$

has changed. The discussion here refers to each selected frame as a keyframe. Each keyframe is denoted as tₖ and it holds:

$${‖ {S}_{{t}_{k}} ‖}_{2} < δ or {A}_{{t}_{k}}^{gripper} \neq {A}_{{t}_{k} + 1}^{gripper} . \qquad ( 2 )$$

where δ is a small velocity threshold.

It is noted that the near-zero joint velocities indicate a change in the robot's direction, and any shift between gripper states implies interactions with objects through the gripper. This approach significantly reduces the length of each episode from more than 200 frames down to 5-15 frames. Nevertheless, the keyframe extraction scheme ensures that important moments are captured and preserved. The terms “important moments” and/or “critical moments” are those moments identified in the video frames that have information on the movement of the robot and useful for predicting next robotic actions. The critical moments are those that contain those robot actions. The term “near-zero” as used here means that the motion has fallen below a threshold.

After finding the keyframes, two main elements are extracted that will be used to construct the ICL prompt. Most existing works leveraging LLMs for robotic planning obtain the center position for each object using segmentation models, such as GroundingDINO and SAM. However, relying on object locations results in poor performance as most robotic tasks require precise and dexterous manipulation.

To address this, the embodiments add the orientation of objects in addition to the center position. Specifically, the location and orientation of each object within the environment at the first timestep t₁ is estimated using an external off-the-shelf pose estimate model. The process uses a set of m object names

$${\{ {M}_{j} \}}_{j = 1}^{M}$$

(e.g., “laptop,” “cable”) in the (e.g., laptop, environment, as done in previous works. This set of object names in the same task remains consistent across all example episodes and during test time.

The discussion denotes the pose estimation process as g, and the pose for the j-th object is then defined as:

$${P}_{j} = g ( V , {M}_{j} ) , \qquad ( 3 )$$

where V is the RGB-D image at the first timestep. Finally, each pose was transformed into the world frame W.

With the keyframes identified, one can extract a sequence of robot actions:

$${\{ {A}_{{t}_{k}} \}}_{k = 2}^{T} .$$

Note the first keyframe is ignored because the initial robot action is always the same. These actions occur within a continuous space, where it is very challenging for the LLMs to perform ICL. To address this, the continuous 6-DoF pose space is discretized into bins and binarize the gripper state. Each translation component

$${A}_{t}^{translation}$$

is discretized into 100 bins, where the total span of these bins is defined by the robot's maximum possible range of motion in that dimension. Similarly, each rotation component

$${A}_{t}^{translation}$$

(in Euler angles)) s discretized into 72 bins, where each bin represents a 5-degree increment. To maintain consistency, the same discretization technique is applied to each object pose.

To simplify the notation, the discussion forms the observation Oⱼ or the j-th object by combining its label Mⱼ with its corresponding discretized pose Pⱼ as textual descriptions:

$${O}_{j} = “ [ {M}_{j} : {P}_{j} \} ”$$

A structured template to form ICL examples from the textual descriptions was constructed and then robot actions with LLMs based on these ICL examples were predicted.

The aim of creating inputs and outputs for an ICL example is to generate the input xᵢ and output yᵢ and this input-output pair serves as an ICL example. The input xᵢ is formulated using the observations for all objects

$${\{ {O}_{j} \}}_{j = 1}^{m}$$

and the language instruction I. The output yᵢ is constructed with robot actions at keyframes

$${\{ {A}_{{t}_{k}} \}}_{k = 2}^{T} .$$

The complete constructed prompt template is shown below:

$${x}^{i} = “ \{ [ {O}_{1} ] , [ {O}_{2} ] , … , [ {O}_{m} ] , [ I ] \} ”$$

$${y}^{i} = “ \{ [ {A}_{t 2} ] , [ {A}_{t 3} ] , … , [ {A}_{t T} ] \} ”$$

To construct the test input x^{Test}, one can apply this prompt template based on a test RGB-D image V^{Test} and a test instruction I. Specifically, first, compute the pose for each object in the test image, denoted as

$${P}_{j}^{Test} ,$$

using Equation 3. Then use the same prompt to generate the test input x^{Test}. Forming the ICL prompt. Since multiple episodes can serve as ICL demonstrations, one can insert a symbol “>” between the input-output pair of each ICL example and separate consecutive pairs with a comma. After listing all ICL examples, the test input x^{Test} is appended at the end. The ICL prompt structure is illustrated as follows:

$${x}^{1} > {y}^{1} , {x}^{2} > {y}^{2} , … , {x}^{n} > {y}^{n} , {x}^{T e s t} >$$

This ICL prompt is then fed into an LLM using Equation 1 to generate a response ŷ^{Test} that contains a sequence of predicted robot actions {Aₜ_{ₖ}}ₖ₌₂^{T} in an autoregressive manner. These actions can be parsed and executed by a robot.

RoboPrompt was evaluated on 16 tasks from RLBench and 6 tasks with a real Franka Emika Panda robot. The results compared the method to both zero-shot (ZS) and ICL methods.

The embodiments employ GPT-4 Turbo as the base LLM and use 10 ICL examples. In simulation, the velocity threshold for keyframe extraction is set to δ=0.1, and use the ground-truth center position of each object as the object poses. In a real robot, the velocity threshold is set to δ=0.01, and a 6-DoF pose was estimated for each object by leveraging FoundationPose with GroundingDino and SAM2.

RoboPrompt was compared to a few ZS and ICL baselines that leverage LLMs or VLMs in robotics. Voxposer builds a 3D voxel map of value functions for predicting waypoints. KAT transforms an object into keypoint tokens and an action into action tokens to perform ICL.

In simulation, for a fair comparison with ZS and ICL baselines, the ground-truth center position for each object was used. In the real world, each baseline uses its own vision module. End-to-end supervised methods, such as RVT-2 and Act3D, in RLBench for reference, were included.

Sixteen tasks on a Franka robot with a parallel gripper from the RLBench simulation were evaluated. The robot is allowed up to 25 steps to complete the task. Results. Table I shows the results of 16 RLBench tasks. RoboPrompt significantly outperforms other ZS and ICL methods with an average success rate of 51.8%, whereas Voxposer and KAT both achieve 21.0%. RoboPrompt can perform better on most tasks under a simple prompt structure in contrast to Voxposer, which requires adjusting prompts for each task. Moreover, compared to KAT, the method does not require transformation from keypoints to actions; instead, the method predicts the actions directly. Note that RoboPrompt underperforms other baselines on the “put in safe” and “put in cupboard” tasks. This is likely because the method does not incorporate the detailed geometry of each object, as the approach uses a single pose to represent the object.

TABLE I
Simulation results on RLBench environment. Each method was evaluated across 16
RLBench tasks. For each task, the average success rate (%) was reported over 25 episodes.
RoboPrompt significantly outperformed various zero-shot and in-context learning
(ICL methods across a wide range of tasks. The supervised methods are grayed out.

| | | | | | | | |
|---|---|---|---|---|---|---|---|
| | | Sweep | | | | | |
| Close | Slide | to | Open | Turn | Stack | Push | Place |
| jar | block | dustpan | drawer | tap | blocks | button | wine |

Supervised methods

| | | | | | | | | |
|---|---|---|---|---|---|---|---|---|
| RVT-2 [54] | 100 | 92 | 100 | 74 | 99 | 80 | 100 | 95 |
| Act3D [55] | 92 | 93 | 92 | 93 | 94 | 12 | 99 | 80 |

Zero-shot and ICL methods

| VoxPoser [23] | 44 | 76 | 0 | 0 | 0 | 68 | 60 | 20 |
|---|---|---|---|---|---|---|---|---|
| KAT [37] | 20 | 52 | 0 | 32 | 48 | 0 | 100 | 28 |
| RoboPrompt | 100 | 80 | 100 | 72 | 100 | 84 | 100 | 52 |
| | | | | | Put | | | |
| | Screw | Put in | Meat | Stack | in | Put in | Sort | Place |
| | bulb | drawer | off grill | cups | safe | cupboard | shape | cups |
| RVT-2 [54] | 88 | 92 | 99 | 80 | 96 | 66 | 95 | 38 |
| Act3D [55] | 47 | 90 | 94 | 9 | 95 | 51 | 8 | 3 |

Zero-Shot and ICL methods

| | | | | | | | | |
|---|---|---|---|---|---|---|---|---|
| VoxPoser [23] | 32 | 0 | 4 | 0 | 0 | 32 | 0 | 0 |
| KAT [37] | 0 | 0 | 16 | 0 | 36 | 0 | 0 | 0 |
| RoboPrompt | 40 | 20 | 16 | 16 | 24 | 16 | 8 | 0 |

In addition, the method demonstrates competitive performance against fully supervised approaches, such as RVT-2 and Act3D, which achieve average success rates of 81.4% and 65.0%, respectively. Unlike these methods, which are trained on hundreds of example episodes using a supervised imitation learning objective, RoboPrompt requires no training on any data. Instead, RoboPrompt leverages the ICL capability of an off-the-shelf LLM to learn robotic tasks with inference only, enabling faster robot learning.

The setup used a 7-DoF Franka Emika Panda robot arm with a parallel jaw gripper, and a low-level Polymetis controller. Each example episode at 6 Hz were recorded. The RGB-D image at the first timestep is captured by the Intel RealSense D435 camera. Both ZS and ICL methods were evaluated on the following 6 tasks: (i) “stack cube”: stack blue/yellow cube on top of the other one, (ii) “destack cube”: destack blue/yellow cube from top of the other, (iii) “push button”: press a red/yellow/green/blue button, (iv) “close laptop”: close the laptop screen, (v) “unplug cable”: disconnect the laptop cable, (vi) “push multiple buttons”: press multiple buttons in a random order. For the “push multiple buttons” task, ICL demonstrations were provided for only pressing a single button. During the test time, each method is given a task instruction to press a sequence of buttons.

TABLE II
Real-robot results. Each method was evaluated across
6 real-world tasks. For each task, the average
success rate was calculated over 10 episodes.
RoboPrompt achieved a betterperformance than
several zero-shot and ICL methods.

| | | | | | | Push |
|---|---|---|---|---|---|---|
| | Stack | Destack | Push | Close | Unplug | multiple |
| | cube | cube | button | laptop | cable | buttons |
| VoxPoser | 80 | 50 | 60 | 30 | 20 | 50 |
| KAT | 60 | 70 | 30 | 20 | 20 | 10 |
| RoboPrompt | 90 | 80 | 90 | 50 | 50 | 80 |

Table II shows the results of real-world tasks. Similar to simulation results, RoboPrompt can achieve an average success rate greater than 80% on simple manipulation tasks (e.g., “stack cube” and “push buttons”). For more complex tasks requiring precise object contact (e.g., “unplug cable,” “close laptop”), RoboPrompt demonstrates reasonable performance, even with only 10 ICL examples.

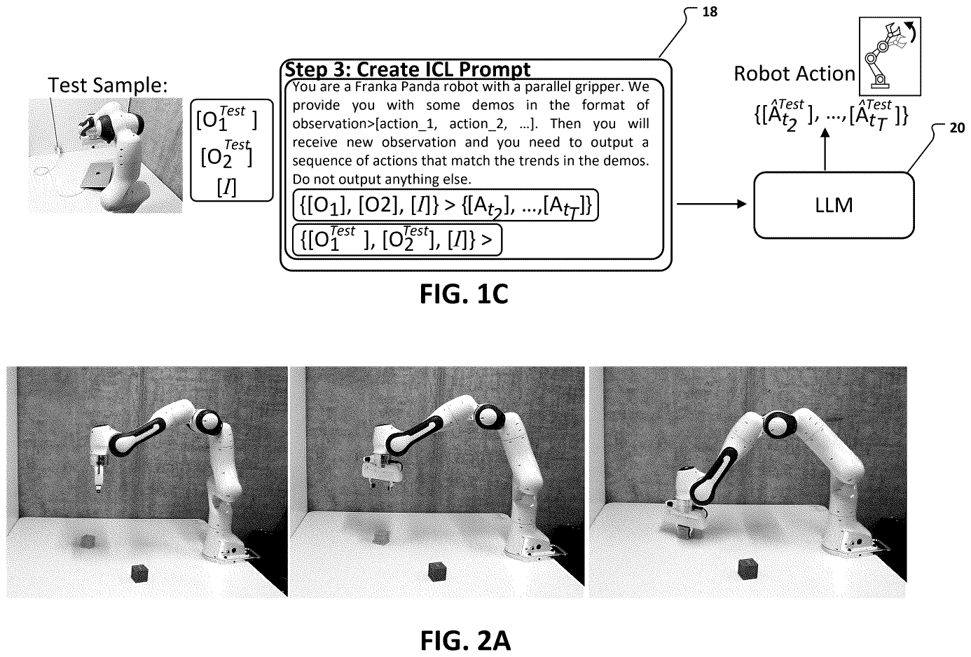

FIGS. 2A-2D shows visualizations of the first few actions predicted by RoboPrompt for some of the tasks in FIGS. 2A-2D. FIG. 2A shows a task of stacking cubes. FIG. 2B shows a task of putting buttons. The robot interacts with the object precisely and the orientation of the gripper closely aligns with that of the relevant objects. More qualitative visualizations are provided below. ICL Emergent property. For the “push multiple buttons” task, ICL examples of pressing just one single button (e.g., “push the red/yellow/green button”) was provided, while during the evaluation, it used a sequence of buttons (e.g., “push the red button, then push the yellow button, and then push the green button”). Remarkably, RoboPrompt can learn during the evaluation to press multiple buttons given a test instruction specifying the order of button pressing with an 80% success rate. This behavior shows that RoboPrompt can learn to perform a new robotic skill by composing a series of single tasks that are available in the ICL demonstrations. FIG. 2C shows a task of “close laptop.”

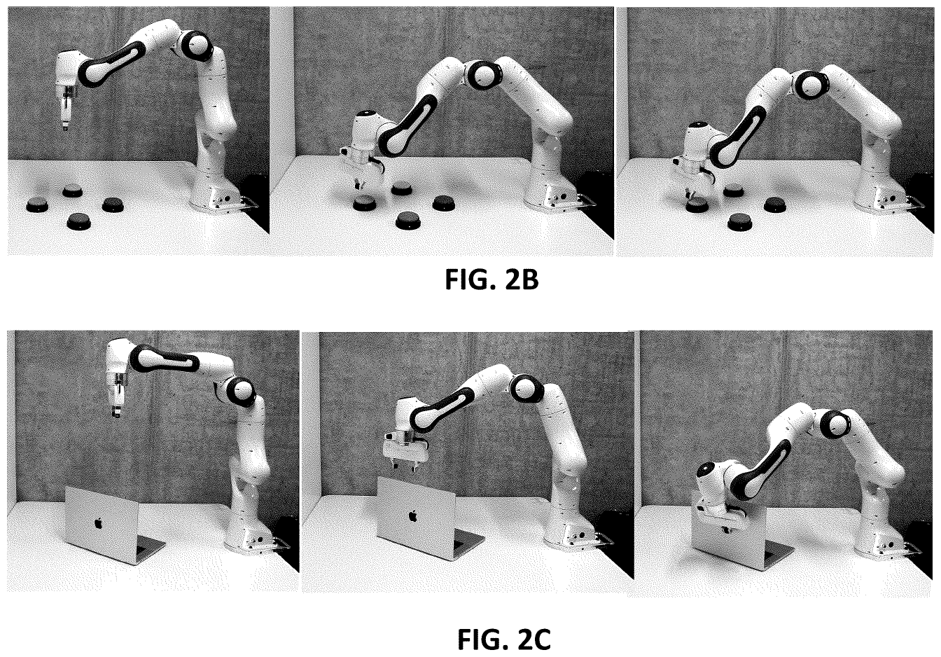

The following discussion provides analysis of various components in RoboPrompt and use 10 ICL examples by default. Additional experiments results are discussed below. The keyframe extraction scheme was ablated. Specifically, keyframe extraction was replaced with uniform action sampling, varying the sampling interval k across {5, 10, 20, 40, 80} frames. The uniformly sampled actions are then used to construct the output in ICL examples. FIG. 3A shows the comparison with the average success rate on the 16 RLBench tasks.

The results show that RoboPrompt with keyframe extraction consistently outperforms the uniform sampling approach, with an average performance increase of nearly 20%. This trend holds across different sampling intervals. This is because smaller sampling intervals lead to longer and less effective ICL examples, which can confuse and mislead LLMs, while longer intervals risk missing crucial actions. The keyframe extraction method mitigates these issues by only adding those critical actions to ICL examples. The number of ICL examples influences the performance of RoboPrompt. The default setup uses 10 ICL examples. To understand the impact of this number, the average success rate of RoboPrompt across 16 RLBench tasks while varying the number of examples was plotted. The results are shown in FIG. 3B.

RoboPrompt's performance increases as ICL examples scale up. This is similar to findings that apply ICL to evaluate LLMs on standard language benchmarks, where more ICL examples lead to better LLMs' performance. Moreover, RoboPrompt achieves an average success rate of approximately 40% even with only 2 ICL examples. Different LLMs. In the setting, RoboPrompt employs GPT-4 Turbo as the default LLM. To evaluate the generality of the approach, GPT-4 Turbo was replaced with other popular LLMs and RoboPrompt's performance on 6 RLBench tasks was assessed. The evaluation ranges from open-source models to those with only API access. As shown in Table III, RoboPrompt consistently achieves high success rates with a variety of LLMs. Moreover, one can observe that stronger LLM leads to better performance of RoboPrompt.

TABLE III
Various LLMs with RoboPrompt.

| | Average Success Rate (%) |
|---|---|
| Llamas3-8B-Inst. | 28.3 |
| GPT-4o mini | 44.8 |
| Qwen2-7B-Inst | 48.8 |
| GPT-4 Turbo | 51.8 |
| GPT-4o | 56.3 |

To assess the impact of pose estimation accuracy on RoboPrompt's performance, Gaussian noise was added into the estimated object poses for both the ICL examples and the test samples. The added noise is scaled by a factor of k∈{0.5, 1, 1.5, 2}, relative to the original pose estimation error. RoboPrompt was assessed on two real-world tasks: “stack cube” and “destack cube.” The average pose estimation errors for the cubes are 1.68 cm in translation and 4.61 degrees in rotation, corresponding to roughly 2% of the environment's spatial range. FIG. 3C shows the results. It can be seen that RoboPrompt is still robust to moderate levels of pose estimation error.

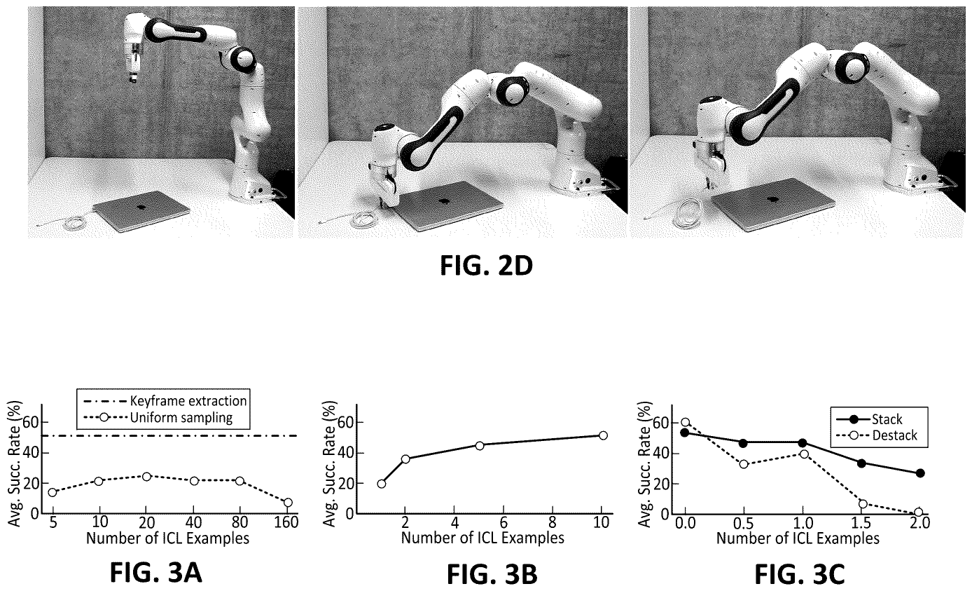

RoboPrompt only takes one observation of all the objects at the first timestep, which is an open loop method. Here, the discussion explores the possibility of closed-loop planning by adding more observations O from a greater number of keyframes. For each ICL example, another observation was added at each keyframe, resulting in a new prompt that contains multiple pairs of observations and corresponding actions. As illustrated in FIG. 4B, this only leads to a 0.7% increase in the average success rate. Therefore, the approach defaults to the open-loop approach: using only a single observation for RoboPrompt due to its simplicity.

The RoboPrompt method was compared to the latest robotics frontier models Octo and LLARVA on two of the real-world tasks. The results are shown in Table IV. Interestingly, RoboPrompt can achieve competitive performance when compared to frontier models that are trained on thousands of robotic episodes.

TABLE IV
Comparison to supervised methods.

| | Destack | Push buttons |
|---|---|---|
| RoboPrompt | 80 | 100 |
| Octo | 40 | 20 |
| LLARVA | 100 | 80 |

The discussion now turns to a more detailed description of the experiments. RoboPrompt predicts robot actions directly through ICL examples. Instead, KAT recently has shown it is also possible to first transform each robot action into action tokens (triplets of 3D points) and then predict action tokens via ICL.

To evaluate the design choice for RoboPrompt, each robot action from the ICL examples was transformed into action tokens and converted the predicted action tokens from LLMs during the test time back to standard 6-DoF actions. FIG. 4A shows the average performance of RoboPrompt with action tokens across 16 RLBench tasks. The results indicate the method does not benefit from performing ICL on action tokens. Thus, the default setting in RoboPrompt is to directly predict robot actions.

Open-loop Vs. closed-loop. By default, RoboPrompt is an open-loop method that only takes one observation at the first timestep. Here, a closed-loop approach was tested by adding more observations from keyframes. Specifically, an ICL example was formed by combining multiple pairs of observations and actions at each keyframe. FIG. 4B shows the comparison across 16 RLBench tasks. The results indicate the closed-loop approach has minimal performance improvement. The open-loop approach for RoboPrompt was selected: taking a single observation at the first timestep.

RoboPrompt employs the same system prompt throughout the experiments shown in FIGS. 1A-1C to form the ICL prompt. However, recent studies have shown the performances of LLMs using ICL are highly sensitive to the prompt design. Here one would like to understand how sensitive RoboPrompt is to the designed system prompt. Specifically, the embodiments form two new system prompts by asking GPT-4o to paraphrase the original one. The original one as well as the two new counterparts are illustrated below:

### a) Original Prompt

“You are a Franka Panda robot with parallel gripper. We provide you with some demos in the format of observation >[action_1, action_1, . . . ]. Then you will receive a new observation and you need to output a sequence of actions that matches the trends in the demos. Do not output anything else.”

### b) First Paraphrased Prompt

“You are an end-effector Franka Panda robot with parallel gripper. We will give you a series of demonstrations in the format observation >[action_1, action_1, . . . ]. Afterward, you will receive a new observation, and your task is to generate a sequence of actions that align with the patterns shown in the demos. Make sure to only output the actions and nothing else.”

### c) Second Paraphrased Plot

“You are a Franka Panda robot with parallel gripper. We will provide you with demonstrations in the format: observation >[action_1, action_1, . . . ]. Afterward, you will receive a new observation, and must generate a sequence of actions that align with the patterns shown in the demos. Ensure that nothing else is included in your output.”

FIG. 4C shows the results of RoboPrompt with above system prompts. Overall, one can observe RoboPrompt's performance varies little across different system prompts.

As additional information on the experiments, RoboPrompt was evaluated on 16 tasks from RLBench simulation. For each task, RoboPrompt was only provided 10 ICL demonstrations and evaluated 25 times. During each evaluation, the objects' positions and orientations in the scene are randomized. The discussion below describes the setup for each task and the task's corresponding success criteria.

The “close jar” task is to put a lid on a target jar. The success criteria are the lid being on top of the target jar and the robot gripper not grasping any object.

The “slide block” task is to slide a block onto a target square. The success criteria are some part of the block being on the specified target square.

The “sweep to dustpan” task is to sweep dirt particles into a target dustpan. The success criteria are all five dirt particles being inside the target dustpan.

The “pen drawer” task is to open the bottom of a drawer. The success criteria are the joint of the drawer fully extended.

The “turn tap” task is to turn the left handle of a tap. The success criteria are the joint of the left handle being at least 90° away from the starting position.

The “stack blocks” task is to stack any 2 of 4 total blocks on the green platform. The success criteria are 2 blocks being inside the area of the green platform.

The task “push button” task is to push a single button. The success criteria are the target button being pressed.

The “place wine” task is to pick up a wine bottle and place it at the middle of a wooden rack. The success criteria are the placement of the bottle at the middle of the rack.

The “screw bulb” task is to pick up a light bulb from the stand and screw it into the bulb stand. The success criteria are the bulb being screwed inside the bulb stand.

The “put in drawer” task is to place a block into the bottom drawer. The success criteria are the placement of the block inside the bottom drawer.

The “meat off grill” task is to take a piece of chicken off the grill and put it on the side. The success criteria are the placement of the chicken on the side, away from the grill.

The “stack cups” task is to stack two cups inside the target one. The success criteria for this task are two cups being inside the target one.

The “put in safe” task is to pick up a stack of money and place it at the bottom shelf of a safe. The success criteria are the stack of money being at the bottom shelf of the safe. Put in cupboard. The task is to place a target grocery inside a cupboard. The success criteria are the placement of the target grocery inside the cupboard.

The “sort shape” task is to pick up a cube and place it in the correct hole in the sorter. The success criteria are the cube being inside the corresponding hole.

The “place cups” task is to place a cup on the cup holder. The success criteria are the alignment of the cup's handle with any spoke on the cup holder.

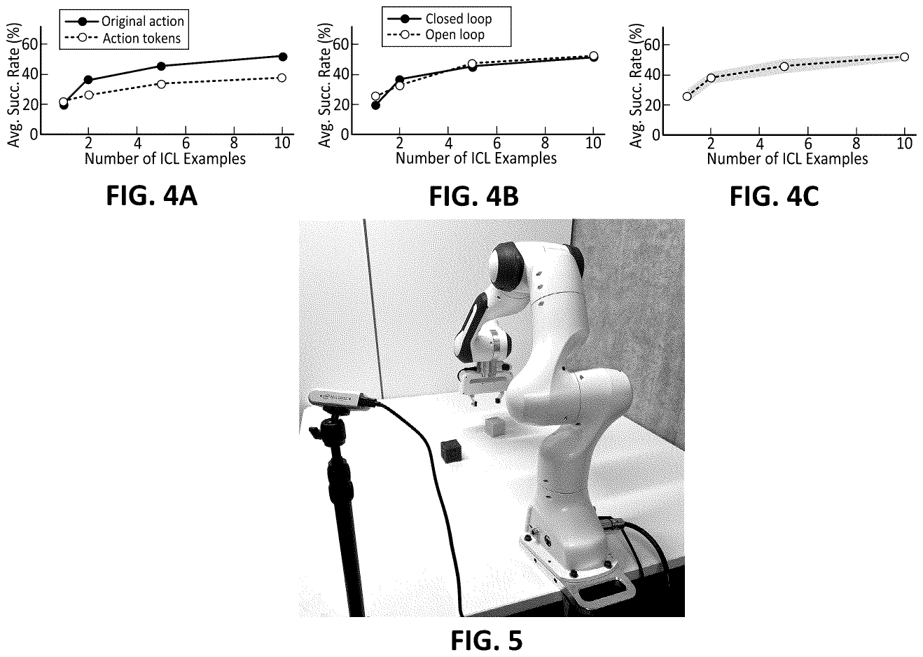

Real-robot experiments were then performed using a Franka Emika Panda robot with a parallel jaw gripper for real robot data collection and evaluations. An Intel RealSense D435 camera positioned on the left of the Franka robot provides an RGB-D visual observation, as shown in FIG. 5. The RGB image is captured at 1920×1080 resolution, and the depth image is aligned to the resolution of the RGB image.

RoboPrompt was evaluated on 6 real-world tasks. When evaluating RoboPrompt on one task, it was provided 10 ICL demonstrations for that task. Note for tasks that involve variations, such as “stack cube,” “destack cube,” “push button,” and “push multiple buttons,” 10 ICL demonstrations are formed from different variations. RoboPrompt is evaluated on each task 10 times. Each time the position and orientation of the object in the scene is randomized. The discussion below describes the setup for each task along with its corresponding success criteria as well as the names of objects and the task instruction provided in each task.

The “stack cube” task is to stack a blue/yellow cube on top of the other. The success criteria are the correct cube being on the top of the other and the robot gripper not grasping anything. The names of objects provided are “blue cube” and “yellow cube.” The language instruction is “stack the blue/yellow cube on the yellow/blue cube.”

The “destack cube” task is to destack a blue/yellow cube from the top of the other. The success criteria are the cube landed on the table. The names of objects provided are “blue cube” and “yellow cube.” The language instruction is “destack the blue/yellow cube that is on the yellow/blue cube.”

The “push button” task is to push a red/yellow/green/blue button. The success criteria are the specified button being pushed. The names of objects provided are “red button,” “yellow button,” “green button,” and “blue button.” The language instruction is “push the red/yellow/green/blue button.”

The “close laptop” task is to close the screen of the laptop. The success criteria are the laptop screen being closed completely. The names of objects provided are “laptop.” The language instruction is “close the laptop.”

The ‘unplug cable” task is to unplug the cable of the laptop. The success criteria are the cable being disconnected from the laptop. The names of objects provided are “laptop” and “cable.” The language instruction is “unplug the laptop.”

The “push multiple buttons” task is to push multiple buttons in a specified order. The success criteria are each button being pressed correctly in a specified order. The names of objects provided are “red button,” “yellow button,” “green button,” and “blue button.” To increase the difficult of this task, only example episodes to push a single button (e.g., the task instruction is “push the red/yellow/green/blue button”) were provided. The evaluation only evaluated pressing a sequence of buttons (e.g., the task instruction is “push the red/yellow/green/blue button, then push the red/yellow/green/blue button, . . . ”). The total number of buttons to be pressed during the evaluation is uniformly sampled from {1, . . . , 6} and the pressing order is randomized.

Building upon the recent success of LLMs, the proposed framework RoboPrompt represents a significant advancement in applying ICL for robotics. In particular, the framework enables off-the-shelf text-only LLMs to directly predict robot actions through ICL demonstrations without training. The embodiments have demonstrated strong performance over several zero-shot and ICL baselines in both simulated and real-world settings. The embodiments mark a meaningful step forward and encourages research in applying ICL to various robotics applications.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Additionally, this written description refers to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

Although specific aspects of this disclosure have been illustrated and described for purposes of illustration, it will be understood that various modifications may be made without departing from the spirit and scope of the invention. Accordingly, the invention should not be limited except as by the appended claims.

1. A robotic device having a large-language model that uses in-context learning to predict robot actions without additional training.

2. The robotic device as claimed in claim 1, wherein the robotic device includes one or more processors configured to execute code that causes the one or more processors to use in-context learning.

3. The robotic device as claimed in claim 2, wherein the code that causes the one or more processors to use in-context learning comprises code that causes the one or processors to:
identify critical moments in a video episode;
estimate object poses from the critical moments in the video episode and convert the object poses into textual descriptions; and
pair the textual descriptions with task instructions to form an in-context learning example for in-context learning.

4. The robotic device as claimed in claim 3, wherein each learning example includes a task instruction, a red-green-blue-depth (RGB-D), and a sequence of several degrees of freedom joint velocities, and a sequence of end-effector actions.

5. The robotic device as claimed in claim 3, wherein the code that causes the one or more processors to identify critical moments comprises moments that contain one or more moments in which robot joint velocities are at or near zero, and a state of a gripper on the robotic device has changed.

6. The robotic device as claimed in claim 3, wherein the code that causes the one or more processors to estimate object poses comprises code that causes the one or more processors to use a pose estimate model.

7. A method of using a large-language model in a robotic device to predict robot actions comprising using in-context learning without additional training.

8. The method as claimed in claim 7, wherein using in-context learning, comprises:
identifying critical moments in a video episode;
estimating object poses from the critical moments in the video episode and converting the object poses into textual descriptions; and
pairing the textual descriptions with task instructions to form an in-context learning example for in-context learning.

9. The method as claimed in claim 8, wherein each learning example includes a task instruction, a red-green-blue-depth (RGB-D), and a sequence of several degrees of freedom joint velocities, and a sequence of end-effector actions.

10. The method as claimed in claim 8, wherein identifying critical moments comprises moments that contain one or more moments in which robot joint velocities are at or near zero, and a state of a gripper on the robotic device has changed.

11. The method as claimed in claim 8, wherein estimating object poses comprising using a pose estimate model.
